(19) United States
(12) Patent Application Publication
(10) Pub. No.: US 2026/0209401 A1
(43) Pub. Date: Jul. 23, 2026

(54) CARBON-EFFICIENT RECYCLING PROCESS FOR PRODUCTION OF POLYMERS FROM WASTE MATERIALS

(71) Applicant: SABIC GLOBAL TECHNOLOGIES B.V., Bergen op Zoom (NL)

(72) Inventors: Nicolas GOYHENEIX, Riemst (BE); Maria SOLIMAN, Selfkant (DE); Raul VELASCO PELAEZ, Katy, TX (US); Johan PASTWA, Elsloo (NL)

(21) Appl. No.: 19/139,965

(22) PCT Filed: Dec. 8, 2023
(86) PCT No.: PCT/EP2023/084948

§ 371 Date: Jun. 17, 2025

(30) Foreign Application Priority Data
Dec. 23, 2022 (EP) 22216599.5

(51) Int. Cl. C08F 10/02; C08F 10/06; C08J 11/14

(52) U.S. Cl. CPC C08F 10/02; C08F 10/06; C08J 11/14; C08J 2323/06; C08J 2323/12

(57) ABSTRACT

A process for recycling waste materials into chemical and polymer materials, the process involving:
a. providing a feed stream of waste;
b. supplying the feed stream to a pyrolysis process to obtain a product slate including an oil product and an offgas stream;
c. subjecting the offgas stream to an offgas processing step to obtain a purified stream;
d. subjecting the oil product to a hydrotreatment step in a hydrotreatment reactor, wherein the purified stream is supplied to the hydrotreatment reactor, from which a hydrotreated stream is obtained;
e. supplying the stream to a processing unit for conversion of hydrocarbons into chemical products, from which a product stream is obtained;
f. subjecting the stream to a separation section for isolating chemical compounds from the stream, to obtain one or more streams of monomer compounds;
g. subjecting the monomer compound(s) to polymerisation reactions in to obtain polymer materials.

### CROSS REFERENCE TO RELATED APPLICATIONS

This application is a National Stage application of PCT/EP2023/084948, filed Dec. 8, 2023, which claims the benefit of European Application No. 22216599.5, filed Dec. 23, 2022, both of which are incorporated by reference in their entirety herein.

### FIELD OF INVENTION

The present invention relates to a carbon-efficient process for production of polymers from waste materials.

### BACKGROUND

The current global drive for significant increase in transitioning production processes into more efficient processes in terms of environmental and social impact has given rise to many efforts to seek for alternatives for traditional production and manufacturing processes.

A particular industry in which such driver may result in substantial advantages is the basic chemical industry. Whilst the basic chemical industry forms an important backbone for today's society, many of the traditional processes employed therein lead to a sizeable footprint; many of the processes require quite an amount of energy, and may involve the consumption of a large share of resources.

Accordingly, the basic chemical industry has engaged in elaborate programs to seek for transitions in support of mitigating the impact of the processes employed, whilst maintaining the ability to supply those products that the global society demands; a demand, which is only foreseen to grow.

A particular segment within the basic chemical industry sector is the production of polymer materials. Conventionally, the most common polymer materials are produced by polymerisation reactions in large-scale polymerisation plants, using an array of chemical compounds as their building blocks. These chemical building blocks, to a significant extent, originate from conversions of fossil resources, such as crude oil, natural gas, and coal, from which they are produced via large-scale industrial processes. Such conversion processes may for example be refining processes, thermal cracking processes, or gasification processes. A great variety of further conversion processes of fossil resources or derivatives thereof into chemical building blocks can be envisioned and are well known in the art.

### SUMMARY

In view of the well-known nature of these processes, one will understand that great advantages can be achieved in terms of transitioning towards more sustainable alternatives, having a reduced footprint. The inventors in the present case have set out endeavours thereto, with emphasis on seeking for processes to manufacture polymers with reduced footprint and energy demand. In the present invention, the inventors report a process for the manufacture of polymer materials.

The process of the present invention involves providing a feed stream of waste (A), which is supplied to a pyrolysis process (1). The feed stream A may comprise plastic materials, preferably waste plastic materials. The feed stream A preferably is a stream of waste plastic materials. See FIG. 1.

### BRIEF DESCRIPTION OF THE DRAWINGS

For a more complete understanding, reference is now made to the following descriptions taken in conjunction with the accompanying drawings, in which:

FIG. 1 illustrates a process for recycling waste materials into chemical and polymer materials.

While the invention is susceptible to various modifications and alternative forms, specific embodiments thereof are shown by way of example in the drawings. The drawings may not be to scale.

### DETAILED DESCRIPTION

The feed stream A may for example comprise a fraction of polyolefin materials. Polyolefin materials are a family of thermoplastic materials that today constitutes the majority of the plastics materials produced globally. As polyolefin materials are to a large extent used in applications that have a limited life span, such as packaging applications, waste plastic streams typically contain a fairly large fraction of polyolefins. Particular types of polyolefin thermoplastics that are commonly present in waste plastics streams are polyethylenes and polypropylenes. Due to their chemical constitution, polyolefin materials are quite suitable for reprocessing via chemical recycling routes. The feed stream A may for example comprise ≥70.0 wt % of polyolefin, preferably ≥80.0 wt %, with regard to the total weight of the steam A. The stream A may for example comprise ≥30.0 wt % of polyethylene, preferably ≥40.0 wt %, more preferably ≥50.0 wt %, even more preferably ≥60.0 wt %, yet even more preferably ≥70.0 wt %, and even more preferably ≥80.0 wt %. The stream A may for example comprise ≥30.0 wt % of polypropylene, preferably ≥40.0 wt %, more preferably ≥50.0 wt %, even more preferably ≥60.0 wt %, yet even more preferably ≥70.0 wt %, and even more preferably ≥80.0 wt %.

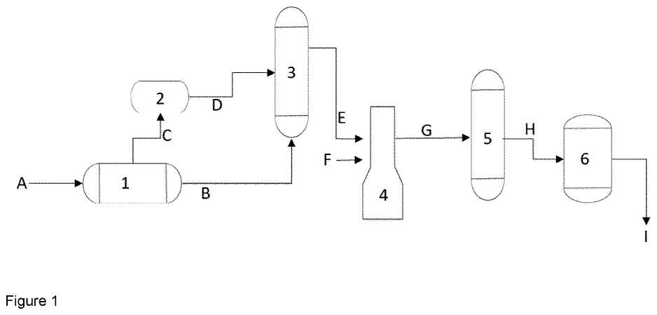

From the pyrolysis process 1, a product slate is obtained that comprises an oil product, which may also be referred to as pyrolysis oil (B), or alternatively pyoil. Furthermore, the product slate comprises an offgas stream (C). See FIG. 1.

The pyrolysis process 1 may be a thermal, non-catalytic, process, or may be a catalytic process. In a catalytic process, an ingredient is added to the process that provides a catalytic function. In a non-catalytic process, no ingredient that provides a catalytic function is further added to the process.

The pyrolysis process may for example be a process operated in batch mode, or may be operated in continuous mode. The pyrolysis process, in the scope of the integrated process of the present invention, may comprise multiple reactor units that each individually are operated in batch mode, in such arrangement that the pyrolysis process overall may be operated in continuous mode. The pyrolysis process may comprise one or more reactor and one or more product tanks, allowing for the reaction products that are obtained from the reactor(s) to be stored in a buffer tank prior to be further used in the process of the present invention. By so, the pyrolysis process may be operated in a quasi-continuous mode, even in the case that the process involves the use of a batch reactor wherein the pyrolysis reaction is terminated upon completion of the reaction, and the reactor needs to be prepared for a subsequent batch.

Alternatively, the pyrolysis process may be operated using one or more continuously operating reactors.

The pyrolysis process may comprise one or more reactors. The reactor(s) may be operated adiabatically, isothermally, non-adiabatically, non-isothermally, or by combined operating modes. In embodiments wherein the pyrolysis process comprises more than one reactor, such reactors may be arranged in series or in parallel configuration.

The reactor(s) each individually may comprise a bed of particulate materials. The particulate materials may be inert materials, catalytic materials, or a combination of both. The bed may be a fixed bed, a fluidized bed, or a slurry bed. The inert material may for example be sand. The particulate materials may be capable of transferring heat to the pyrolysis process.

The particulate materials may be continuously supplied to the process. The particulate materials may be continuously withdrawn from the process. For example, heated sand may be used to provide heat to the pyrolysis process.

The pyrolysis process may involve one or more reactors wherein a catalyst material is employed. Such catalyst material may for example be applied in the form of a solid particulate material. The catalyst material may for example be a zeolite-type catalyst.

The pyrolysis process may, in certain embodiments, be operated as a thermal process. In such thermal pyrolysis process, the heat that is required for conducting the reaction may be provided by internal means, such as by providing heated inert particulate materials such as hot sand. Alternatively, the required heat may be supplied by external heating of the reactor. The reactor may comprise an agitation means.

The pyrolysis process may for example be operated at temperatures of ≥350 and ≤650° C., preferably of ≥400 and ≤600° C. When operated at such temperatures, the pyrolysis process provides a desirable product slate, without excessive generation of undesirable byproducts.

It is preferred that the reactions in the reactor(s) in the pyrolysis process are performed in the absence of oxygen.

The pyrolysis oil B may for example be a product stream comprising paraffins, olefins, naphthenes, and aromatics. In the context of the present invention, olefins are to be understood to be acyclic hydrocarbon compounds comprising one or more unsaturations. For example, the pyrolysis oil B may have an initial boiling point of ≥25° C., and a final boiling point of ≤350° C., preferably an initial boiling point of ≥50° C. and a final boiling point of ≤350° C. The initial and final boiling points of the pyrolysis oil B may be determined in accordance with ASTM D86 (2012).

The pyrolysis oil B may comprise a quantity of unsaturated hydrocarbons. For example, the pyrolysis oil B may comprise ≥1.0 and ≤30.0 wt % of unsaturated hydrocarbons, or ≥5.0 wt % and ≤25.0 wt %, or ≥10.0 and ≤25.0 wt %. For example, the pyrolysis oil B may comprise ≥1.0 and ≤30.0 wt % of olefins, or ≥5.0 wt % and ≤25.0 wt %, or ≥10.0 and ≤25.0 wt %.

The pyrolysis oil B may for example comprise a quantity of paraffin compounds, such as ≥40.0 wt % of paraffin compounds, more preferably ≥50.0 wt %, even more preferably ≥60.0 wt %. The pyrolysis oil B may for example comprise ≥40.0 and ≤90.0 wt % of paraffin compounds, preferably ≥50.0 and ≤80.0 wt %, more preferably ≥50.0 and ≤70.0 wt. In the context of the present invention, paraffin compounds are to be understood to be acyclic unsaturated hydrocarbon compounds The presence of such content of paraffin compounds in the pyrolysis oil B contributes to qualifying the pyrolysis oil for use in a steam cracking conversion process to produce a steam cracking product slate comprising a high fraction of chemical compounds that are suitable for use in production of thermoplastic polymer materials, in particular thermoplastic polyolefin materials.

The pyrolysis oil B may for example comprise ≥10.0 wt % of n-paraffin compounds, preferably ≥20.0 wt %, more preferably ≥30.0 wt %, more preferably ≥40.0 wt %. The pyrolysis oil B may for example comprise ≥10.0 and ≤70.0 wt % of n-paraffin compounds, preferably ≥20.0 and ≤50.0 wt %, more preferably ≥30.0 and ≤50.0 wt %.

The pyrolysis oil B may for example comprise ≥5.0 wt % of iso-paraffin compounds, preferably ≥10.0 wt %, more preferably ≥15.0 wt %. The pyrolysis oil B may for example comprise ≥5.0 and ≤30.0 wt % of iso-paraffin compounds, preferably ≥10.0 and ≤25.0 wt %, more preferably ≥15.0 and ≤25.0 wt %.

The offgas stream C comprises a fraction of methane and a fraction of hydrogen. Whilst both of these products in themselves may be valuable products, in the offgas stream they are typically present as in the form of a mixture, in certain embodiments even in combination with further hydrocarbon gases, such as C2-C4 gaseous hydrocarbon compounds. In certain embodiments, the offgas stream C may comprise quantities of carbon monoxide and/or carbon dioxide.

In particular, there is a need to secure the hydrogen that may be obtained from the pyrolysis process in an appropriately purified form. To achieve this, the process of the present invention involves an offgas processing step (2). This offgas processing step may involve a separation and/or purification step. In this step (2), the offgas stream C may be treated in such way that a purified stream comprising hydrogen (D) is obtained. Such treatment may involve conversion of methane and/or other gaseous hydrocarbon compounds in the offgas stream C into hydrogen, to increase the hydrogen content in the stream D.

It is preferred that the stream D comprises ≥50.0 wt % of hydrogen, preferably ≥60.0 wt %, more preferably ≥70.0 wt %, with regard to the total weight of the stream D.

The suitability of the pyrolysis oil B for processing in a subsequent steam cracking operation may be improved by subjecting the pyrolysis oil B to a hydrotreatment process. In such hydrotreatment process, unsaturations that may be present in the oily compounds of the pyrolysis oil may be eliminated by reaction of the compounds with hydrogen. Furthermore, cleavage of certain of the heteroatoms that may be present in the compounds of the pyrolysis oil may occur by reaction with hydrogen, thereby reducing the quantity of heteroatoms in the pyrolysis oil stream. Accordingly, the process of the present invention involves a hydrotreatment step (3), in which the pyrolysis oil B is subjected to hydrotreatment.

The hydrotreatment may be performed at a temperature of ≥250° C. and ≤500° C., preferably of ≥250° C. and ≤400° C.

The hydrotreatment may be performed at a pressure of ≥5.0 and ≤150.0 MPa, preferably of ≥5.0 and ≤100 MPa.

The hydrotreatment may be performed using a catalyst comprising an active metal, for example a metal selected from nickel, cobalt, tungsten and molybdenum, preferably wherein the active metal is supported on a support selected from silica, alumina or titania.

The hydrotreatment involves the supply of hydrogen from stream D. Stream D may be partly or completely supplied to the hydrotreatment step 3. Preferably, the stream D is completely supplied to the hydrotreatment step 3.

Furthermore, additional hydrogen may be provided to the hydrotreatment step 3. Such additional supply of hydrogen may be needed, depending on the quality of the pyrolysis oil B, which again is depending on the quality of the feed stream A. An aim of the process of the present invention is to limit the fraction of hydrogen that needs to be externally sourced to the process, thereby improving the materials efficiency of the process.

The hydrotreatment may be performed in a single reaction vessel, or may involve multiple reaction steps in series, for example wherein one of the reaction steps involves a dewaxing reaction.

The hydrotreatment step 3 results in a stream E. The stream E may for example comprise or consist of a hydrocarbon mixture having an initial boiling point of ≥25° C., and a final boiling point of ≤350° C., preferably an initial boiling point of ≥50° C. and a final boiling point of ≤350° C. The initial and final boiling points may be determined in accordance with ASTM D86 (2012).

As a result of the hydrotreatment step 3, unsaturations that were present in the compounds in pyrolysis oil B have been hydrogenated to form saturated bonds in the compounds. Stream E thus comprises a reduced quantity of hydrocarbon compounds comprising unsaturated bonds compared to the pyrolysis oil stream B. Stream E preferably comprises ≤2.0 wt % of olefins, more preferably ≤1.5 wt %, even more preferably ≤1.0 wt %.

Stream E may for example comprise ≥0.2 and ≤2.0 wt % of olefins, more preferably ≥0.2 and ≤1.5 wt %, even more preferably ≥0.2 and ≤1.0 wt %. When stream E comprises such low fraction of olefins, the stream E can be used in subsequent thermal processing by for example steam cracking at high contents. In steam cracking operations, the presence of excessive amounts of olefins may lead to undesired polymerisation reactions in the cracker furnaces.

Accordingly, it is desirable to obtain a stream E from the hydrotreatment wherein the fraction of olefins is particularly low.

The stream E may for example comprise a quantity of paraffin compounds, such as ≥50.0 wt % of paraffin compounds, more preferably ≥60.0 wt %, even more preferably ≥70.0 wt %. The pyrolysis oil B may for example comprise ≥50.0 and ≤95.0 wt % of paraffin compounds, preferably ≥60.0 and ≤95.0 wt %, more preferably ≥65.0 and ≤90.0 wt. The presence of such content of paraffin compounds in the stream E contributes to qualifying the product for use in a steam cracking conversion process to produce a steam cracking product slate comprising a high fraction of chemical compounds that are suitable for use in production of thermoplastic polymer materials, in particular thermoplastic polyolefin materials.

The stream E may for example comprise ≥25.0 wt % of n-paraffin compounds, preferably ≥35.0 wt %, more preferably ≥40.0 wt %, more preferably ≥45.0 wt %. The stream E may for example comprise ≥25.0 and ≤70.0 wt % of n-paraffin compounds, preferably ≥40.0 and ≤60.0 wt %, more preferably ≥45.0 and ≤60.0 wt %.

The stream E may for example comprise ≥20.0 wt % of iso-paraffin compounds, preferably ≥25.0 wt %, more preferably ≥30.0 wt %. The stream E may for example comprise ≥20.0 and ≤45.0 wt % of iso-paraffin compounds, preferably ≥25.0 and ≤45.0 wt %, more preferably ≥25.0 and ≤40.0 wt %.

In the process according to the present invention, the stream E is supplied to a processing unit (4) for conversion of hydrocarbons, in particular liquid hydrocarbons, into chemical products, in particular into a product stream comprising olefins, preferably a high fraction of olefins.

In addition to the stream E, a further feed stream (F) may in certain embodiments be supplied to the processing unit 4. For example, the feed stream F may be a hydrocarbon feed stream, for example a naphtha-range hydrocarbon feed stream. Stream F may for example have an initial boiling point of ≥25° C., and a final boiling point of ≤350° C., preferably an initial boiling point of ≥50° C. and a final boiling point of ≤350° C. Stream F may for example comprise <0.2 wt % of olefins, preferably <0.15 wt %, more preferably <0.1 wt %.

For example, such processing unit may be a steam cracker unit. [specification of cracker]

The product stream (G) that is obtained from the processing unit is subjected to a separation section (5). Via such separation section, which may contain multiple separation units, preferably in an integrated process layout, isolated streams of desirable chemical compounds may be obtained, in desirable degree of purity for further conversion in chemical or polymer synthesis processes. From separation section 5, one or more stream (H) of monomer compounds is obtained. For example, the separation section may result in an ethylene stream that is suitable for use in an ethylene polymerisation process. The separation section may result in a propylene stream that is suitable for use in a propylene polymerisation process.

Such ethylene stream may be used in an ethylene polymerisation process to obtain an ethylene-based polymer.

Such propylene stream may be used in a propylene polymerisation process to obtain a propylene-based polymer.

Other streams that may be isolated from the separation section may be used for the production of chemicals or other polymers.

From such ethylene polymerisation process or such propylene polymerisation process, or other polymerisation processes using isolated streams from the separation section, end products, such as consumer products, may be manufactured that, upon arriving at the end of their service life and thereupon being disposed of, may be collected to form part of the feed stream A.

In that way, the process of the present invention provides for an efficient circular solution to process waste plastics and produce novel, virgin quality polymer materials. By so, the solution of the present invention may contribute to abatement of the use of fossil hydrocarbon feed materials in the production of polymer materials.

In certain embodiments of the invention, an offgas stream (J) may be obtained from the processing unit 4. Such offgas stream J may comprise a fraction of methane and a fraction of hydrogen. In certain embodiments further hydrocarbon gases, such as C2-C4 gaseous hydrocarbon compounds, may be present in the stream J. The stream J may be supplied to the offgas processing step 2. By so, the efficiency of use of hydrogen may be improved, so that the quantity of hydrogen that for the process needs to be sourced from external sources is reduced.

The invention thus relates to a process for recycling waste materials into chemical and polymer materials, the process involving:
a. providing a feed stream of waste (A);
b. supplying the feed stream A to a pyrolysis process (1) to obtain a product slate comprising an oil product (B) and an offgas stream (C) comprising a fraction of methane and a fraction of hydrogen;
c. subjecting the offgas stream C to an offgas processing step (2), preferably a separation and/or purification step, to obtain a purified stream (D) comprising hydrogen;
d. subjecting the oil product B to a hydrotreatment step (3) in a hydrotreatment reactor, wherein the stream D comprising hydrogen is supplied to the hydrotreatment reactor, from which a hydrotreated stream (E) is obtained;
e. supplying the stream E to a processing unit (4) for conversion of hydrocarbons into chemical products, from which a product stream (G) is obtained;
f. subjecting the stream G to a separation section (5) for isolating chemical compounds, including polymerisable compounds, from the stream G, to obtain one or more streams (H) of monomer compounds;
g. subjecting the monomer compound(s) H to polymerisation reactions in one or more polymerisation process (6) to obtain polymer materials (I).

Such process allows for the chemical recycling of waste materials, such as waste plastic materials, with improved hydrogen efficiency in the process.

1. A process for recycling waste materials into chemical and polymer materials, the process involving:
a. providing a feed stream of waste (A);
b. supplying the feed stream A to a pyrolysis process (1) to obtain a product slate comprising an oil product (B) and an offgas stream (C) comprising a fraction of methane and a fraction of hydrogen;
c. subjecting the offgas stream C to an offgas processing step (2) to obtain a purified stream (D) comprising hydrogen;
d. subjecting the oil product B to a hydrotreatment step (3) in a hydrotreatment reactor, wherein the purified stream D comprising hydrogen is supplied to the hydrotreatment reactor, from which a hydrotreated stream (E) is obtained; e. supplying the stream E to a processing unit (4) for conversion of hydrocarbons into chemical products, from which a product stream (G) is obtained;
f. subjecting the stream G to a separation section (5) for isolating chemical compounds, including polymerisable compounds, from the stream G, to obtain one or more streams (H) of monomer compounds;
g. subjecting the monomer compound(s) H to polymerisation reactions in one or more polymerisation process (6) to obtain polymer materials (I).

2. The process according to claim 1, wherein the feed stream A comprises plastic materials.

3. The process according to claim 1, wherein the feed stream A comprises >70.0 wt % of polyolefin materials, with regard to the total weight of the feed stream A.

4. The process according to claim 1, wherein the pyrolysis process 1 is operated at temperatures of >350° C. and <650° C.

5. The process according to claim 1, wherein the stream D comprises >50.0 wt % of hydrogen, prefer with regard to the total weight of the stream D.

6. The process according to claim 1, wherein the processing unit 4 is a steam cracker unit.

7. The process according to claim 1, wherein the feed to the processing unit 4 comprises the stream E and a further feed stream (F).

8. The process according to claim 1, wherein the one or more streams H comprise an ethylene stream and/or a propylene stream.

9. The process according to claim 8, wherein the ethylene stream is subjected to an ethylene polymerisation process to obtain an ethylene-based polymer.

10. The process according to claim 8, wherein the propylene stream is subjected to a propylene polymerisation process to obtain a propylene-based polymer.

11. The process according to claim 1. wherein an offgas stream (J) is obtained from the processing unit 4, wherein the stream J comprises hydrogen and methane, and wherein the stream J is supplied to the offgas processing step 2.

12. The process according to claim 1, wherein the stream E comprises <2.0 wt % of olefins.

13. The process according to claim 1. wherein the stream E comprises >50.0 wt % of paraffin compounds.

14. The process according to claim 1, wherein the pyrolysis process 1 is a thermal non-catalytic process.

15. The process according to claim 1, wherein the hydrotreatment step 3 is a catalytic process.
